(19) United States
(12) Patent Application Publication
(10) Pub. No.: US 2007/0300185 A1
(43) Pub. Date: Dec. 27, 2007

(54) ACTIVITY-CENTRIC ADAPTIVE USER INTERFACE

(75) Inventors: Steven W. Macbeth, Snohomish, WA (US); Roland L. Fernandez, Woodinville, WA (US); Brian R. Meyers, Issaquah, WA (US); Desney S. Tan, Kirkland, WA (US); George G. Robertson, Seattle, WA (US); Nuria M. Oliver, Seattle, WA (US); Oscar E. Murillo, Seattle, WA (US); Elin R. Pedersen, Seattle, WA (US); Mary P. Czerwinski, Woodinville, WA (US); Michael D. Pinckney, Clyde Hill, WA (US); Jeanine E. Spence, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/426,804

(22) Filed: Jun. 27, 2006

(51) Int. Cl. G06F 17/00

(52) U.S. Cl. 715/825; 715/517

(57) ABSTRACT

The innovation enables “total system” experiences for activities and activity-specialized experiences for applications and gadgets that allow them to align more closely with the user, his work, and his goals. In particular, the system provides for dynamically changing the user interface (UI) of the system level shell (“desktop”), of applications, and of standalone UI parts (“gadgets”), based upon a current (or future) activity of the user and other context data. The system can consider context data that includes extended activity data, information about the user's state, and information about the current environment. Preprogrammed and/or inferred rules can be used to decide how to adapt the UI based upon the activity. These rules can include, user rules, group rules, and device rules. Additionally, activities and applications can also participate in the decision of how to adapt the UI.

### CROSS REFERENCE TO RELATED APPLICATION(S)

This application is related to U.S. patent application Ser. No. ______ (Attorney Docket Number MS315859.01/MSFTP1290US) filed on Jun. 27, 2006, entitled “LOGGING USER ACTIONS WITHIN ACTIVITY CONTEXT”, ______ (Attorney Docket Number MS315860.01/MSFTP1291US) filed on Jun. 27, 2006, entitled “RESOURCE AVAILABILITY FOR USER ACTIVITIES ACROSS DEVICES” ______ (Attorney Docket Number MS315861.01/MSFTP1292US) filed on Jun. 27, 2006, entitled “CAPTURE OF PROCESS KNOWLEDGE FOR USER ACTIVITIES”, ______ (Attorney Docket Number MS315862.01/MSFTP1293US) filed on Jun. 27, 2006, entitled “PROVIDING USER INFORMATION TO INTROSPECTION”, ______ (Attorney Docket Number MS315863.01/MSFTP1294US) filed on Jun. 27, 2006, entitled “MONITORING GROUP ACTIVITIES”; ______ (Attorney Docket Number MS315864.01/MSFTP1295US) filed on Jun. 27, 2006, entitled “MANAGING ACTIVITY-CENTRIC ENVIRONMENTS VIA USER PROFILES ______ (Attorney Docket Number MS315865.01/MSFTP1296US) filed on Jun. 27, 2006, entitled “CREATING AND MANAGING ACTIVITY-CENTRIC WORKFLOW” ______ (Attorney Docket Number MS315867.01/MSFTP1298US) filed on Jun. 27, 2006, entitled “ACTIVITY-CENTRIC DOMAIN SCOPING”, and ______ (Attorney Docket Number MS315868.01/MSFTP1299US) filed on Jun. 27, 2006, entitled “ACTIVITY-CENTRIC GRANULAR APPLICATION FUNCTIONALITY”. The entirety of each of the above applications is incorporated herein by reference.

### BACKGROUND

Conventionally, communications between humans and machines has not been natural. Human-human communication typically involves spoken language combined with hand and facial gestures or expressions, and with the humans understanding the context of the communication. Human-machine communication is typically much more constrained, with devices like keyboards and mice for input, and symbolic or iconic images on a display for output, and with the machine understanding very little of the context. For example, although communication mechanisms (e.g., speech recognition systems) continue to develop, these systems do not automatically adapt to the activity of a user. As well, traditional systems do not consider contextual factors (e.g., user state, application state, environment conditions) to improve communications and interactivity between humans and machines.

Activity-centric concepts are generally directed to ways to make interaction with computers more natural (by providing some additional context for the communication). Traditionally, computer interaction centers around one of three pivots, 1) document-centric, 2) application-centric, and 3) device-centric. However, most conventional systems cannot operate upon more than one pivot simultaneously, and those that can do not provide much assistance managing the pivots. Hence, users are burdened with the tedious task of managing every little aspect of their tasks/activities.

A document-centric system refers to a system where a user first locates and opens a desired data file before being able to work with it. Similarly, conventional application-centric systems refer to first locating a desired application, then opening and/or creating a file or document using the desired application. Finally, a device-centric system refers to first choosing a device for a specific activity and then finding the desired application and/or document and subsequently working with the application and/or document with the chosen device.

Accordingly, since the traditional computer currently has little or no notion of activity built in to it, users are provided little direct support for translating the “real world” activity they are trying to use the computer to accomplish and the steps, resources and applications necessary on the computer to accomplish the “real world” activity. Thus, users traditionally have to assemble “activities” manually using the existing pieces (e.g., across documents, applications, and devices). As well, once users manually assemble these pieces into activities, they need to manage this list mentally, as there is little or no support for managing this on current systems.

All in all, the activity-centric concept is based upon the notion that users are leveraging a computer to complete some real world activity. Historically, a user has had to outline and prioritize the steps or actions necessary to complete a particular activity mentally before starting to work on that activity on the computer. Conventional systems do not provide for systems that enable the identification and decomposition of actions necessary to complete an activity. In other words, there is currently no integrated mechanism available that can dynamically understand what activity is taking place as well as what steps or actions are necessary to complete the activity.

Most often, the conventional computer system has used the desktop metaphor, where there was only one desktop. Moreover, these systems stored documents in a single filing cabinet. As the complexity of activities rises, and as the similarity of the activities diverges, this structure does not offer user-friendly access to necessary resources for a particular activity.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a system for dynamically changing the user interface (UI) of a system level shell (“desktop”), of applications, and of standalone UI parts (“gadgets” or “widgets”), based upon a current (or future) activity of the user and other context data. In aspects, the context data can include extended activity data, information about the user's state, and information about the environment.

In disparate aspects, preprogrammed and/or inferred rules can be used to decide how to adapt the UI based upon the activity. These rules can include user rules, group rules, and device rules. Optionally, activities and applications can also participate in the decision of how to adapt the UI. In all, the system enables “total system” experiences for activities and activity-specialized experiences for applications and gadgets, allowing them all to align more closely with the user, his work, and his goals.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates a system that facilitates activity-based adaptation of a user interface (UI) in accordance with an aspect of the innovation.

FIG. 2 illustrates an exemplary flow chart of procedures that facilitate adapting a UI based upon an identified activity in accordance with an aspect of the innovation.

FIG. 3 illustrates an exemplary flow chart of procedures that facilitate adapting a UI based upon a determined context in accordance with an aspect of the innovation.

FIG. 4 illustrates an exemplary flow chart of procedures that facilitate adapting a UI based upon a variety of activity-associated factors in accordance with an aspect of the innovation.

FIG. 5 illustrates an architectural diagram of an overall activity-centric computing system in accordance with an aspect of the innovation.

FIG. 6 illustrates an exemplary architecture including a rules-based engine and a UI generator component that facilitates automation in accordance with an aspect of the innovation.

FIG. 7 illustrates an exemplary block diagram of a system that generates an adapted UI model in accordance with an activity.

FIG. 8 illustrates a high level overview of an activity-centric UI system in accordance with an aspect of the innovation.

FIG. 9 illustrates a sampling of the kinds of data that can comprise the activity-centric context data in accordance with an aspect of the innovation.

FIG. 10 illustrates a sampling of the kinds of information that can comprise the activity-centric adaptive UI rules in accordance with an aspect of the innovation.

FIG. 11 illustrates a sampling of the kinds of information that can comprise the application UI model in accordance with an aspect of the innovation.

FIG. 12 illustrates a sampling of the kinds of information that can be analyzed by a machine learning engine to establish learned rules in accordance with an aspect of the innovation.

FIG. 13 illustrates a block diagram of a computer operable to execute the disclosed architecture.

FIG. 14 illustrates a schematic block diagram of an exemplary computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, user, and/or intent from a set of observations as captured via events and/or data. Captured data and events can include user data, device data, environment data, data from sensors, sensor data, application data, implicit and explicit data, etc. Inference can be employed to identify a specific context or action, or can generate a probability distribution over states, for example. The inference can be probabilistic, that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

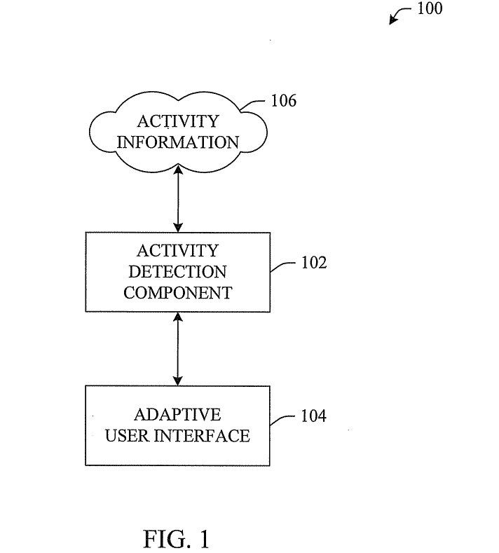

Referring initially to the drawings, FIG. 1 illustrates a system 100 that facilitates automatic user interface (UI) adaptation in accordance with an aspect of the innovation. More particularly, the system 100 can include an activity detection component 102 and an adaptive UI component 104. In operation, the activity detection component 102 can automatically detect (or infer) an activity from activity information 106 (e.g., user actions, user state, context). Accordingly, the adaptive UI component 104 can facilitate rendering specific UI resources based upon the determined and/or inferred activity.

The novel activity-centric features of the subject innovation can make interaction with computers more natural and effective than conventional computing systems. In other words, the subject innovation can build the notion of activity into aspects of the computing experience thereby providing support for translating the “real world” activities into computing mechanisms. The system 100 can automatically and/or dynamically identify steps, resources and application functionality associated with a particular “real world” activity. The novel features of the innovation can alleviate the need for a user to pre-assemble activities manually using the existing mechanisms. Effectively, the subject system 100 can make the “activity” a focal point to drastically enhance the computing experience.

As mentioned above, the activity-centric concepts of the subject system 100 are directed to new techniques of interaction with computers. Generally, the activity-centric functionality of system 100 refers to a set of infrastructure that initially allows a user to tell the computer (or the computer to determine or infer) what activity the user is working on—in response, the computer can keep track of, monitor, and make available resources based upon the activity. Additionally, as the resources are utilized, the system 100 can monitor the particular resources accessed, people interacted with, websites visited, web-services interacted with, etc. This information can be employed in an ongoing manner thus adding value through tracking these resources. It is to be understood that resources can include, but are not to be limited to include, documents, data files, contacts, emails, web-pages, web-links, applications, web-services, databases, images, help content, etc.

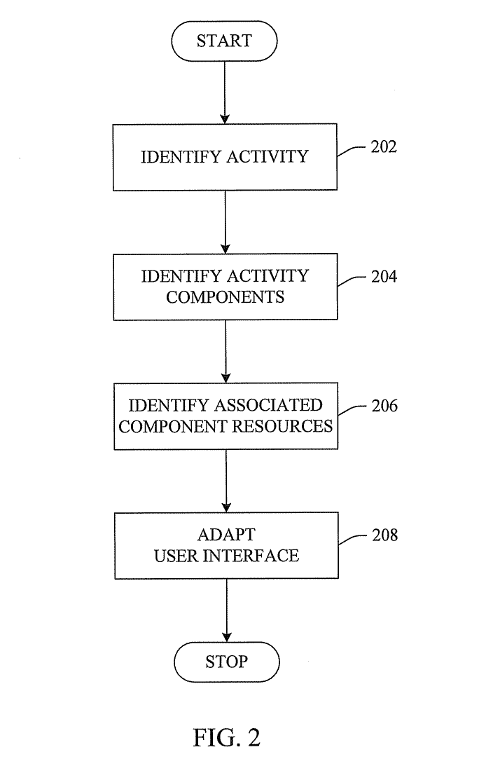

FIG. 2 illustrates a methodology of adapting a UI to an activity in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 202, an activity of a user can be determined. As will be described in greater detail below, the activity can be explicitly determined by a user. Similarly, the user can schedule activities for future use. Still further, the system can determine and/or infer the activity based upon user actions and other information.

By way of example, the system can monitor a user's current actions thereafter comparing the actions to historical data to determine or assess the current user activity. As well, the system can employ a user's context (e.g., state, location, etc.) and other information (e.g., calendar, personal information management (PIM) data) thereafter inferring a current and/or future activity.

Once the activity is determined, at 204, the system can identify components associated with the particular activity. For example, the components can include, but are not limited to include, application functionalities and the like. Correspondingly, additional component associated resources can be identified at 206. For instance, the system can identify files that can be used with a particular activity component.

At 208, the UI can be adapted and rendered to a user. Effectively, the innovation can evaluate the gathered activity components and resources thereafter determining and adapting the UI accordingly. It is a novel feature of the innovation to dynamically adapt the UI based upon the activity as well as surrounding information. In another example, the system can consider the devices being used together with the activity being conducted in order to dynamically adapt the UI.

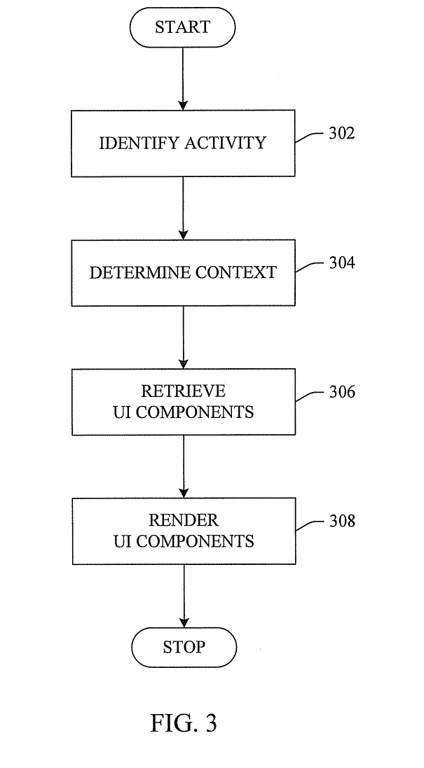

FIG. 3 illustrates an alternative methodology of adapting a UI to an activity in accordance with an aspect of the innovation. More particularly, the methodology illustrated in FIG. 3 considers context to determine an appropriate UI layout, inclusion and/or flow and thereafter render activity components. At 302, an activity can be identified either explicitly, inferred or a combination thereof.

Context factors can be determined at 304. By way of example, a user's physical/mental state, location, state within an application or activity, etc. can be determined at 304. As well, a device context can be determined at 304. For example, context factors related to currently employed user devices and/or available devices can be determined.

In accordance with the gathered contextual data, UI components can be retrieved at 306 and rendered at 308. In accordance with the novel aspects of the innovation, the UI can be modified and/or tailored with respect to a particular activity. As well, the UI can be tailored to other factors, e.g., device type, user location, user state, etc. in addition to the particular activity.

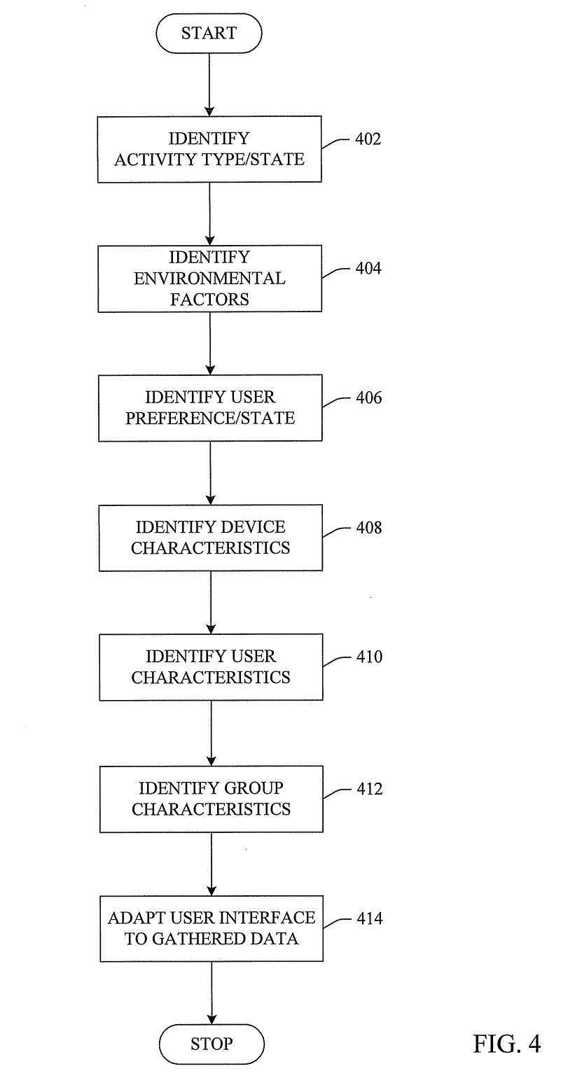

FIG. 4 illustrates yet another methodology of gathering data and adapting a UI in accordance with an aspect of the innovation. While the methodology suggests identifying particular data, it is to be understood that additional data or a subset of the data shown can be gathered in alternative aspects. As well, it is to be understood that “identify” is intended to include determining from an explicit definition from monitoring and/or tracking user action(s), inferring (e.g., implicitly determining from observed data) using machine learning and reasoning (MLR) mechanisms, determining from explicit input from the user, as well as a combination thereof.

With reference to FIG. 4, at 402, the activity type and state can be determined. For example, suppose the type of activity is planning a party, the state could be preparing invitations, shopping for gifts (e.g., locating stores, e-commerce websites), etc. Other contextual information can be gathered at 404 thru 410. More particularly, environmental factors, user preference/state, device characteristics, user characteristics and group characteristics can be gathered at 404, 406, 408 and 410 respectively. All, or any subset, of this information can be employed to selectively render an appropriate UI with respect to the activity and/or state within the activity.

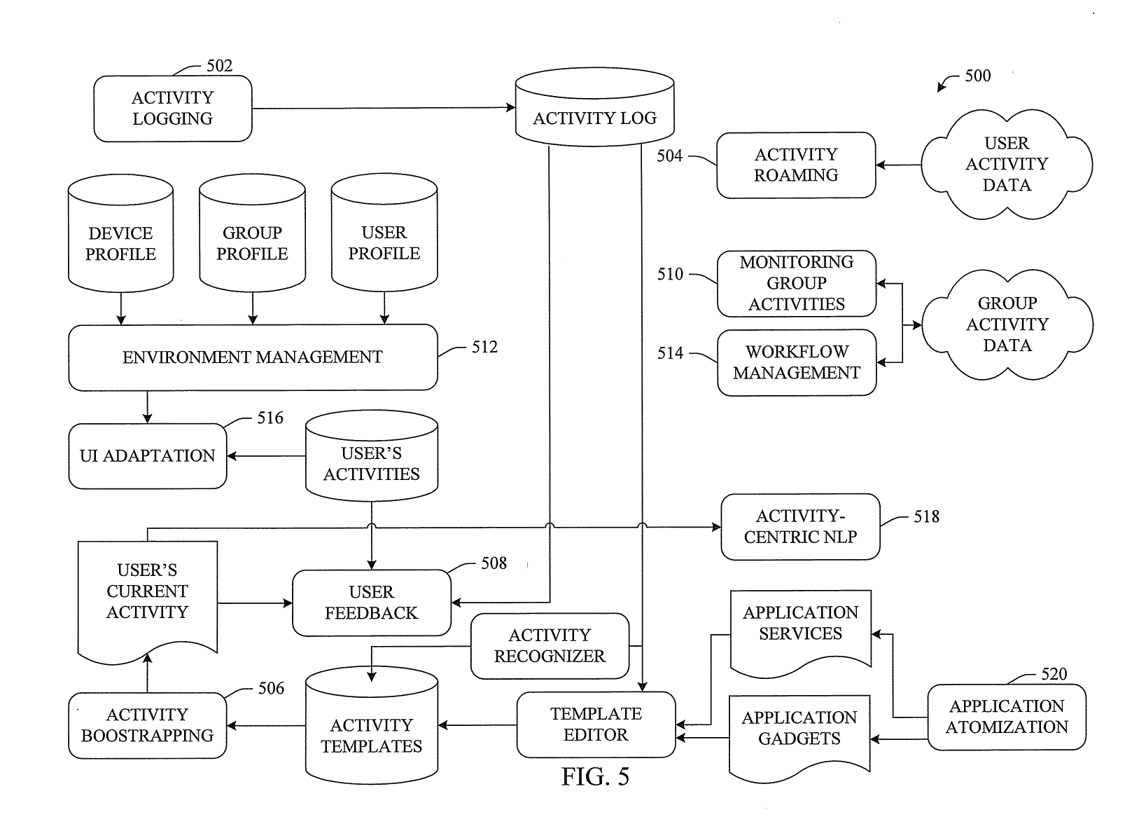

Turning now to FIG. 5, an overall activity-centric system 500 operable to perform novel functionality described herein is shown. As well, it is to be understood that the activity-centric system of FIG. 5 is illustrative of an exemplary system capable of performing the novel functionality of the Related Applications identified supra and incorporated by reference herein. Novel aspects of each of the components of system 500 are described below.

The novel activity-centric system 500 can enable users to define and organize their work, operations and/or actions into units called “activities.” Accordingly, the system 500 offers a user experience centered on those activities, rather than pivoted based upon the applications and files of traditional systems. The activity-centric system 500 can also usually include a logging capability, which logs the user's actions for later use.

In accordance with the innovation, an activity typically includes or links to all the resources needed to perform the activity, including tasks, files, applications, web pages, people, email, and appointments. Some of the benefits of the activity-centric system 500 include easier navigation and management of resources within an activity, easier switching between activities, procedure knowledge capture and reuse, improved management of activities and people, and improved coordination among team members and between teams.

As described herein and illustrated in FIG. 5, the system 500 discloses an extended activity-centric system. However, the particular innovation (e.g., novel adaptive UI functionality) disclosed herein is part of the larger, extended activity-centric system 500. An overview of this extended system 500 follows.

The “activity logging” component 502 can log the user's actions on a device to a local (or remote) data store. By way of example, these actions can include, but are not limited to include, user interactions (for example, keyboard, mouse, and touch input), resources opened, files changed, application actions, etc. As well, the activity logging component 502 can also log current activity and other related information such as additional context data (e.g., user emotional/mental state, date, activity priority (e.g., high, medium low) as well as deadlines, etc. This data can be transferred to a server that holds the user's aggregated log information from all devices used. The logged data can later be used by the activity system in a variety of ways.

The “activity roaming” component 504 is responsible for storing each of the user's activities, including related resources and the “state” of open applications, on a server and making them available to the device(s) that the user is currently using. As well, the resources can be made available for use on devices that the user will use in the future or has used in the past. The activity roaming component 504 can accept activity data updates from devices and synchronize and/or collaborate them with the server data.

The “activity boot-strapping” component 506 can define the schema of an activity. In other words, the activity boot-strapping component 506 can define the types of items it can contain. As well, the component 506 can define how activity templates can be manually designed and authored. Further, the component 506 can support the automatic generation, and tuning of templates and allow users to start new activities using templates. Moreover, the component 506 is also responsible for template subscriptions, where changes to a template are replicated among all activities using that template.

The “user feedback” component 508 can use information from the activity log to provide the user with feedback on his activity progress. The feedback can be based upon comparing the user's current progress to a variety of sources, including previous performances of this or similar activities (using past activity log data) as well as to “standard” performance data published within related activity templates.

The “monitoring group activities” component 510 can use the log data and user profiles from one or more groups of users for a variety of benefits, including, but not limited to, finding experts in specific knowledge areas or activities, finding users that are having problems completing their activities, identifying activity dependencies and associated problems, and enhanced coordination of work among users through increased peer activity awareness.

The “environment management” component 512 can be responsible for knowing where the user is, the devices that are physically close to the user (and their capabilities), user state (e.g., driving a car, alone versus in the company of another), and helping the user select the devices used for the current activity. The component 512 is also responsible for knowing which remote devices might be appropriate to use with the current activity (e.g., for processing needs or printing).

The “workflow management” component 514 can be responsible for management, transfer and collaboration of work items that involve other users, devices and/or asynchronous services. The assignment/transfer/collaboration of work items can be ad-hoc, for example, when a user decides to mail a document to another user for review. Alternatively, the assignment/transfer of work items can be structured, for example, where the transfer of work is governed by a set of pre-authored rules. In addition, the workflow manager 514 can maintain an “activity state” for workflow-capable activities. This state can describe the status of each item in the activity, for example, who or what it is assigned to, where the latest version of the item is, etc.

The “UI adaptation” component 516 can support changing the “shape” of the user's desktop and applications according to the current activity, the available devices, and the user's skills, knowledge, preferences, policies, and various other factors. The contents and appearance of the user's desktop, for example, the applications, resources, windows, and gadgets that are shown, can be controlled by associated information within the current activity. Additionally, applications can query the current activity, the current “step” within the activity, and other user and environment factors, to change their shape and expose or hide specific controls, editors, menus, and other interface elements that comprise the application's user experience.

The “activity-centric recognition” component or “activity-centric natural language processing (NLP)” component 518 can expose information about the current activity, as well as user profile and environment information in order to supply context in a standardized format that can help improve the recognition performance of various technologies, including speech recognition, natural language recognition, desktop search, and web search.

Finally, the “application atomization” component 520 represents tools and runtime to support the designing of new applications that consist of services and gadgets. This enables more fine-grained UI adaptation, in terms of template-defined desktops, as well as adapting applications. The services and gadgets designed by these tools can include optional rich behaviors, which allow them to be accessed by users on thin clients, but deliver richer experiences for users on devices with additional capabilities.

In accordance with the activity-centric environment 500, once the computer understands the activity, it can adapt to that activity in order to assist the user in performing it. For example, if the activity is the review of a multi-media presentation, the application can display the information differently as opposed to an activity of the UI employed in creating a multi-media presentation. Although some existing applications attempt to hard code a limited number of fixed activities within themselves, the activity-centric environment 500 provides an platform for creating activities within and across any applications, websites, gadgets, and services. All in all, the computer can react and tailor functionality and the UI characteristics based upon a current state and/or activity. The system 500 can understand how to bundle up the work based upon a particular activity. Additionally, the system 500 can monitor actions and automatically bundle them up into an appropriate activity or group of activities. The computer will also be able to associate a particular user to a particular activity, thereby further personalizing the user experience.

All in all, the activity-centric concept of the subject system 500 is based upon the notion that users can leverage a computer to complete some real world activity. As described supra, historically, a user would outline and prioritize the steps or actions necessary to complete a particular activity mentally before starting to work on that activity on the computer. In other words, conventional systems do not provide for systems that enable the identification and decomposition of actions necessary to complete an activity.

The novel activity-centric systems enable automating knowledge capture and leveraging the knowledge with respect to previously completed activities. In other words, in one aspect, once an activity is completed, the subject innovation can infer and remember what steps were necessary when completing the activity. Thus, when a similar or related activity is commenced, the activity-centric system can leverage this knowledge by automating some or all of the steps necessary to complete the activity. Similarly, the system could identify the individuals related to an activity, steps necessary to complete an activity, documents necessary to complete, etc. Thus, a context can be established that can help to complete the activity next time it is necessary to complete. As well, the knowledge of the activity that has been captured can be shared with other users that require that knowledge to complete the same or a similar activity.

Historically, the computer has used the desktop metaphor, where there was effectively only one desktop. Moreover, conventional systems stored documents in a filing cabinet, where there was only one filing cabinet. As the complexity of activities rises, and as the similarity of the activities diverges, it can be useful to have many virtual desktops available that can utilize identification of these similarities in order to streamline activities. Each individual desktop can be designed to achieve a particular activity. It is a novel feature of the innovation to build this activity-centric infrastructure into the operating system such that every activity developer and user can benefit from the overall infrastructure.

The activity-centric system proposed herein is made up of a number of components as illustrated in FIG. 5. It is the combination and interaction of these components that compromises an activity-centric computing environment and facilitates the specific novel functionality described herein. At the lowest level the following components make up the core infrastructure that is needed to support the activity-centric computing environment; Logging application/user actions within the context of activities, User profiles and activity-centric environments, Activity-centric adaptive user interfaces, Resource availability for user activities across multiple devices and Granular applications/web-services functionality factoring around user activities. Leveraging these core capabilities with a number of higher-level functions are possible, including; providing user information to introspection, creating and managing workflow around user activities, capturing ad-hoc and authored process and technique knowledge for user activities, improving natural language and speech processing by activity scoping, and monitoring group activity.

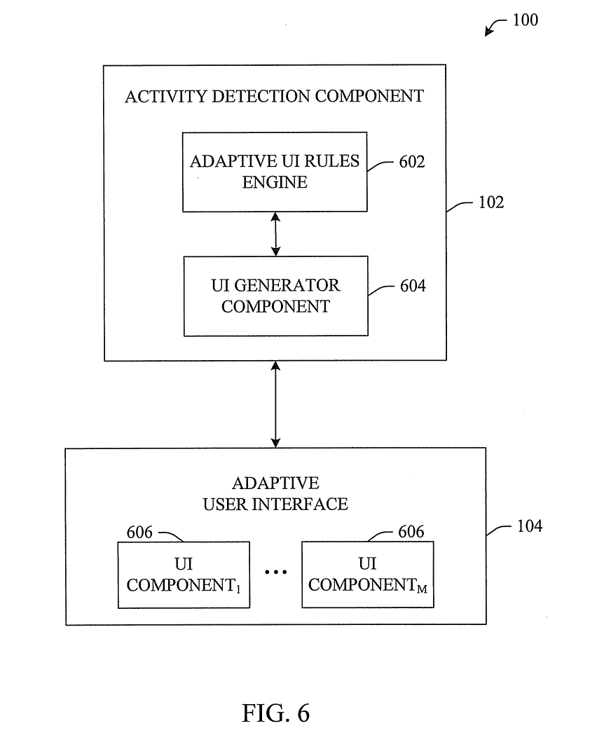

Referring now to FIG. 6, an alternative system 600 in accordance with an aspect of the innovation is shown. Generally, system 600 includes an activity detection component 102 having an adaptive rules engine 602 and a UI generator component 604 included therein. Additionally, an adaptive UI 104 is shown having 1 to M UI components therein, where M is an integer. It is to be understood that 1 to M UI components can be referred to individually or collectively as UI components 606.

In operation, the system 600 can facilitate adjusting a UI in accordance with the activity of a user. As described supra, in one aspect, the activity detection component 102 can detect an activity based upon user action, current behavior, past behavior or any combination thereof. As illustrated the activity detection component 102 can include an adaptive UI rules engine 602 that enables developers to build adaptive UI components 606 using a declarative model that describes the capabilities of the adaptive UI 104, without requiring a static layout of UI components 606, inclusion or flow. In other words, the adaptive UI rules engine 602 can interact with a model (not shown) to define the UI components 602 thereafter determining the adaptive UI 104 layout, inclusion or flow with respect to an activity.

As well, the adaptive UI rules engine component 602 can enable developers and activity authors to build and define adaptive UI experiences using a declarative model that describes the user experience, the activities and tasks supported by the experience and the UI components 606 that should be consolidated with respect to an experience.

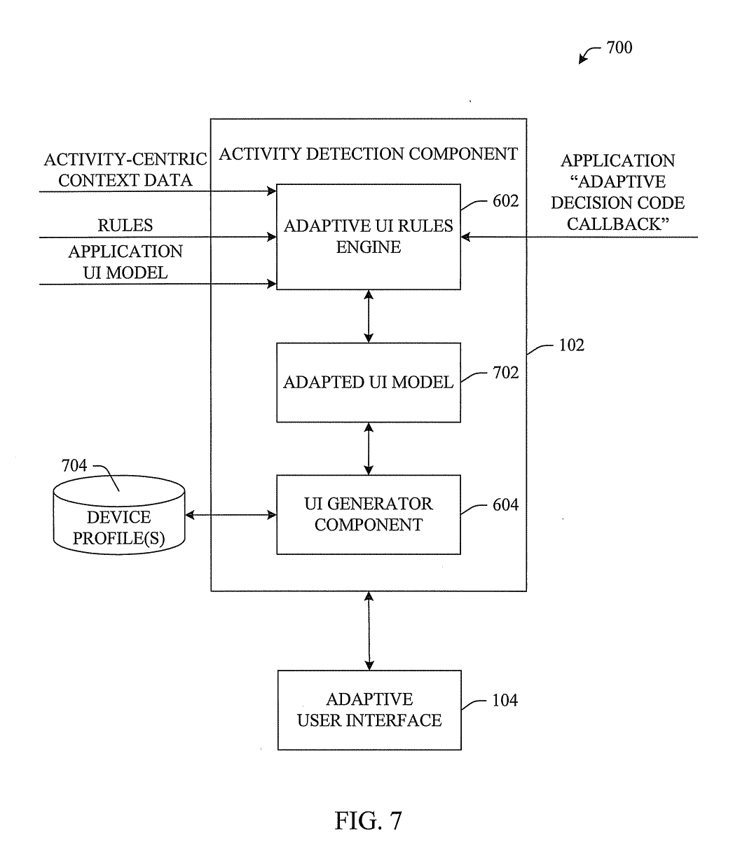

Referring now to FIG. 7, block diagram of an alternative system 700 is shown. Generally, system 700 includes an activity detection component 102 having an adaptive UI rules engine 602 that communicates with an adapted UI model 702 and a UI generator 604. As shown, the UI generator 604 can communicate with device profile(s) 704 in order to determine an appropriate UI layout, inclusion and/or flow.

As shown, the adaptive UI rules engine 602 can evaluate activity-centric context data and an application UI model. In other words, the adaptive UI rules engine 602 can evaluate the activity-centric context data and the application UI model in view of pre-defined (or inferred) rules. Accordingly, an adapted UI model 702 can be established.

The UI generator component 604 can employ the adapted UI model 702 and device profile(s) 704 to establish the adapted UI interface 104. In other words, the UI generator component 604 can identify the adapted UI interface 104 layout, inclusion and flow.

The system 700 can provide a dynamically changing UI based upon an activity or group of activities. In doing so, the system 700 can consider both the context of the activity the user is currently working on, as well as environmental factors, resources, applications, user preferences, device types, etc. In one example, the system can adjust the UI of an application based upon what the user is trying to accomplish with a particular application. As compared to existing applications which generally have only a fixed, or statically changeable UI, this innovation allows a UI to dynamically adapt based upon what the user was trying to do, as well as other factors as outlined above.

In one aspect, the system 700 can adapt in response to user feedback and/or based upon a user state of mind. Using different input modalities, the user can express intent and feelings. For example, if a user is happy or angry, the system can adapt to express error messages in a different manner and can change the way options are revealed, etc. The system can analyze pressure on a mouse, verbal statements, physiological signals, etc. to determine state of mind. As well, user statements can enable the system to infer that there has not been a clear understanding of an error message, accordingly, the error message can be modified and displayed in a different manner in an attempt to rectify the misunderstanding.

In another aspect, the system can suggest a different device (e.g., cell phone) based upon an activity or state within the activity. The system can also triage multiple devices based upon the activity. By way of further example, the system can move the interface for a phone-based application onto a nearby desktop display thereby permitting interaction via a keyboard and mouse when it senses that the user is trying to do something more complex than is convenient or possible via the phone.

In yet another aspect, the system 700 can further adapt the UI based upon context. For example, the ringer can be modified consistent with the current activity or other contextual information such as location. Still further, system 700 can determine from looking at the user's calendar that they are in a meeting. In response, if appropriate, the ringer can be set to vibrate (or silent) mode automatically thus eliminating the possibility for interruption. Similarly, a different greeting and notification management can be modified based upon a particular context. The UI can also color code files within a file system based upon a current activity in order to highlight interesting and relevant files in view of a past, current or future activity.

As discussed above, today, the overall look and feel of an application graphical UI (GUI) is essentially always the same. For example, when a word processor is launched, the application experience is essentially the same with the exception to some personalized features (e.g., toolbars, size of view, colors, etc.). In the end, even if a user personalizes an application it is still essentially the same UI, optimized for the same activity, regardless of what the user is actually doing. However, conventional UIs cannot dynamically adapt to particulars of an activity.

One novel feature of the subject innovation is the activity-centric adaptive UI which can understand various types of activities and behave differently when a user is working on those activities. At a very high level, an application developer can design and the system 700 can dynamically present (e.g., render) rich user experiences customized to a particular activity. By way of example, a word processing application can behave differently in letter writing activity, a school paper writing activity and in a business plan writing activity.

In accordance with the innovation, computer systems and applications can adapt the UI in accordance with an activity being executed from a much more granular level. By way of particular example and continuing with the previous word processing example, when a user is writing a letter, there is a large amount of word processing functionality that is no longer needed to accomplish the activity. For instance, a table of contents or footnotes is not likely to be inserted into the letter. Therefore, this functionality is not needed and can be filtered. In addition to not being required, these functionalities can often confuse the simple activity of writing a letter. Moreover, these unused functionalities can sometimes occupy valuable memory and often slow processing speed of some devices.

Thus, in accordance with the novel functionality of the adaptive UI component 104, the user can inform the system of the activity or types of activities they are working on. Alternatively, the system can infer from a user's actions (as well as from other context factors) what activity or group of activities is being executed. In response thereto, the UI can be dynamically modified in order to optimize for that activity.

In addition to the infrastructure that enables supplying information to the system thereafter adapting the UI, the innovation can provide a framework that allows an application developer to retrieve this information from the system in order to effectuate the adaptive user experience. For example, the system can be queried in order to determine an experience level of a user, what activity they are working on, what are the capabilities of the device being used, etc.

Effectively, in accordance with aspects of the novel innovation, the application developer can establish a framework that effectively builds two types of capabilities into their applications. The first is a toolbox of capabilities or resources and the other is a toolbox of experiences (e.g., reading, editing, reviewing, letter writing, grant writing, etc.). Today, there is no infrastructure available for the developer that is defining the experiences to identify which the tools are necessary for each experience. As well, conventional systems are not able to selectively render tools based upon an activity.

Another way to look at the subject innovation is that the activity-centric adaptive UI can be viewed as a tool match-up for applications. For example, a financial planning application can include a toolbox having charting, graphing, etc. where the experiences could be managing finances for seniors, college funding, etc. As such, in accordance with the subject innovation, these experiences can pool the resources (e.g., tools) in order to adapt to a particular activity.

With respect to adaptation, the innovation can address adaptation in multiple levels, including, system level for things like desktop and favorites and “my documents”, cross-application levels and application levels. In accordance therewith, adaptation can work in real time. In other words, as the system detects a particular pattern of actions, it can make tools more readily available thereby adapting in real time. Thus, in one aspect, part of the adaptation can involve machine learning. Not only can developers take into account a user action, but the system can also learn from actions and predict or infer actions thereby adapting in real time. These machine learning aspects will be described in greater detail infra.

Further, the system can adapt to the individual as well as the aggregate. For instance, the system can determine that everyone (or a group of users) is having a problem in a particular area, thus adaptation is proper. As well, the system can determine that an individual user is having a problem in an area, thus adaptation is proper.

Moreover, in order to determine who the user is as well as an experience level of a user, the system can ask the user or alternatively, can predict via machine learning based upon some activity or pattern of activity. In one aspect, identity can be effected by requiring a user login and/or password. However, machine learning algorithms can be employed to infer or predict factors to drive automatic UI adaptation. It is to be understood and appreciated that there can also be an approach that includes a mixed initiative system, for example, where machine learning algorithms are further improved and refined with some explicit input/feedback from one or more users.

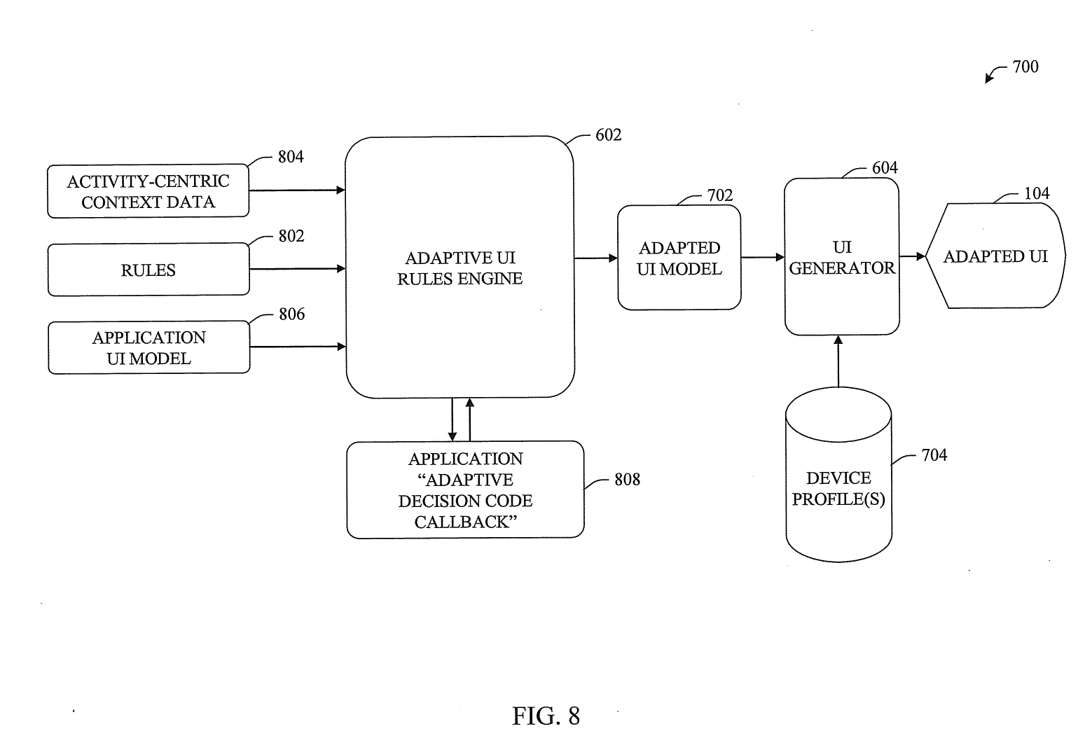

Referring now to FIG. 8, an alternative architectural block diagram of system 700 is shown. As described above, the subject innovation discloses a system 700 that can dynamically change the UI of a system level shell (e.g., “desktop”) of applications, and of standalone UI parts (e.g., “gadgets”). The UI can be dynamically adapted based upon an activity of the user and other context data. As will be shown in the figures that follow, the context data can include extended activity data, information about the user's state, and information about the current environment, etc.

The rules can be employed by the adaptive UI rules engine 602 to decide how to adapt the UI. It is to be understood that the rules can included user rules, group rules, device rules or the like. Optionally, disparate activities and applications can also participate in the decision of how to adapt the interface. This system enables “total system” experiences for activities and activity-specialized experiences for applications and gadgets, allowing them all to align more closely with the user, his work, and his goals.

With continued reference to FIG. 8, a high level overview of the activity-centric UI system 700 is shown. In operation, the adaptive UI rules engine 602 can evaluate the set of rules 802. These rules 802 can take the activity-centric context data 804 as an input. Additionally, the rules 802 can perform operations on the application UI model 806 to produce the adapted UI model 702. This new model 702 can be input into the UI generator 604, together with information about the current device(s) (e.g., device profile(s) 704). As a result, a novel adapted UI 104 can be dynamically generated.

As shown in FIG. 8, an application can also contain “adaptive decision code” 808 that can allow the application to participate with the adaptive UI rules engine 602 in formulating decisions on how the UI is adapted. This novel feature of an application having a UI model (e.g., 806) that participates in the decisions of the adaptive UI rules engine 602 to dynamically adapt the UI can also be applied to activities and gadgets in accordance with alternative aspects of the innovation. These alternative aspects are to be included within the scope of the innovation and claims appended hereto.

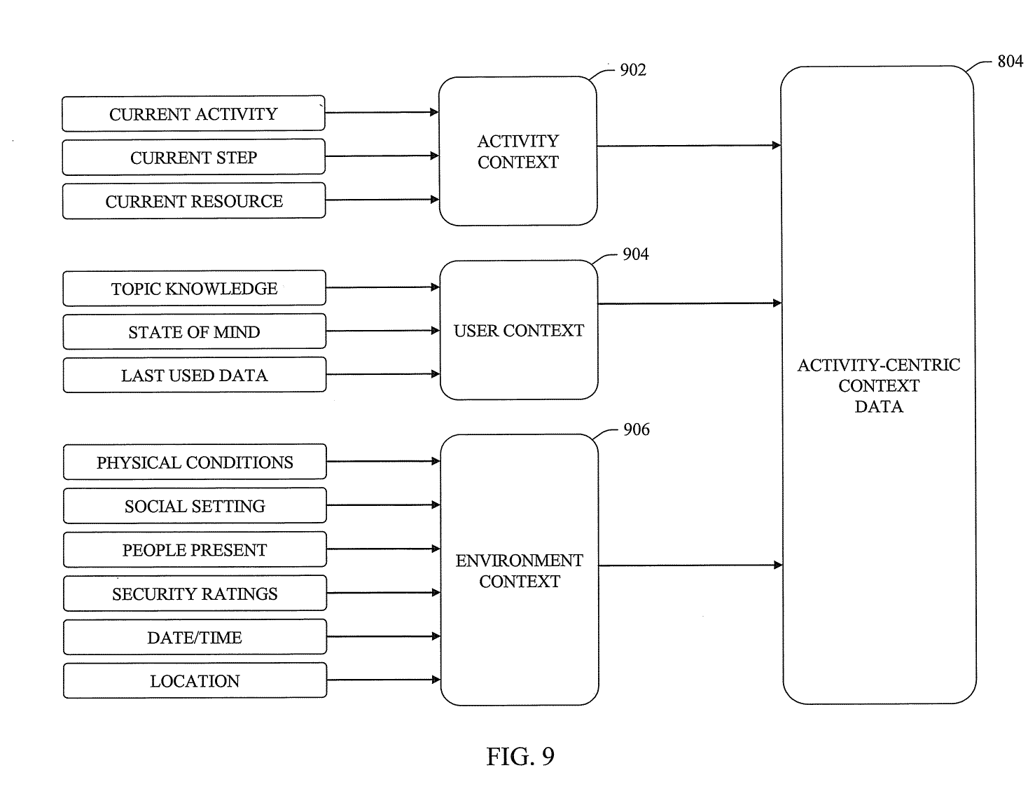

FIG. 9 illustrates a sampling of the kinds of data that can comprise the activity-centric context data 802. In accordance with the aspect illustrated in FIG. 9, the activity-centric context data 802 can be divided into 3 classes: activity context 902, user context 904, and environment context 904.

By way of example, and not limitation, the activity context data 902 includes the current activity the user is performing. It is to be understood that this activity information can be explicitly determined and/or inferred. Additionally, the activity context data 902 can include the current step (if any) within the activity. In other words, the current step can be described as the current state of the activity. Moreover, the activity context data 902 can include a current resource (e.g., file, application, gadget, email, etc.) that the user is interacting with in accordance with the activity.

In an aspect, the user context data 904 can include topics of knowledge that the user knows about with respect to the activity and/or application. As well, the user context data 904 can include an estimate of the user's state of mind (e.g., happy, frustrated, confused, angry, etc.). The user context can also include information about when the user most recently used the current activity, step, resource, etc.

It will be understood and appreciated that the user's state of mind can be estimated using different input modalities, for example, the user can express intent and feelings, the system can analyze pressure and movement on a mouse, verbal statements, physiological signals, etc. to determine state of mind. In another example, content and/or tone of a user statement can enable the system to infer that there has not been a clear understanding of the error message; accordingly, the error message can be modified and rendered in order to rectify the misunderstanding.

With continued reference to FIG. 9, the environment context data 906 can include the physical conditions of the environment (e.g., wind, lighting, ambient, sound, temperature, etc.), the social setting (e.g., user is in a business meeting, or user is having dinner with his family), the other people who are in the user's immediate vicinity, data about how secure the location/system/network are, the date and time, and the location of the user. As stated above, although specific data is identified in FIG. 9, it is to be understood that additional types of data can be included within the activity centric context data 804. As well, it is to be understood that this additional data is to be included within the scope of the disclosure and claims appended hereto.

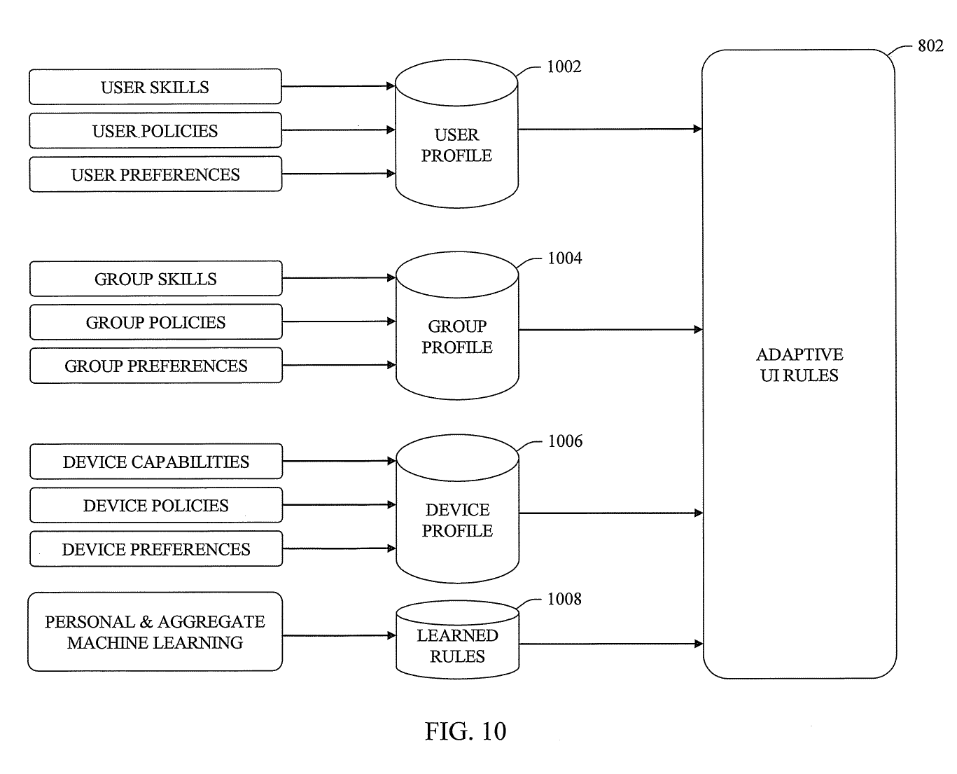

FIG. 10 illustrates exemplary types of rules 802 that can be processed by the adaptive UI rules engine (602 of FIG. 6). Generally, the adaptive UI rules 802 can include user rules, group rules, device rules, and machine learned rules. In operation and in disparate aspects, these rules can be preprogrammed, dynamically generated and/or inferred. Additionally, it is to be understood that the rules 802 can be maintained locally, remotely or a combination thereof.

As shown, the user rules 802 can reside in a user profile data store 1002 and can include an assessment of the user's skills, user policies for how UI adaptation should work, and user preferences. The group rules can reside in a group profile data store 1004 and can represent rules applied to all members of a group. In one aspect, the group rules can include group skills, group policies and group preferences.

The device rules can reside in a device profile data store 1006 and can define the device (or group of devices) or device types that can be used in accordance with the determined activity. For example, the identified device(s) can be chosen from known local and/or remote devices. Additionally, the devices can be chosen based upon the capabilities of each device, the policies for using each device, and the optimum and/or preferred ways to use each device.

The learned rules 1008 shown in FIG. 10 can represent the results of machine learning that the system has accomplished based at least in part upon the user and/or the user's devices. It is to be understood that the machine learning functionality of the innovation can be based upon learned rules aggregated from any number of disparate users.

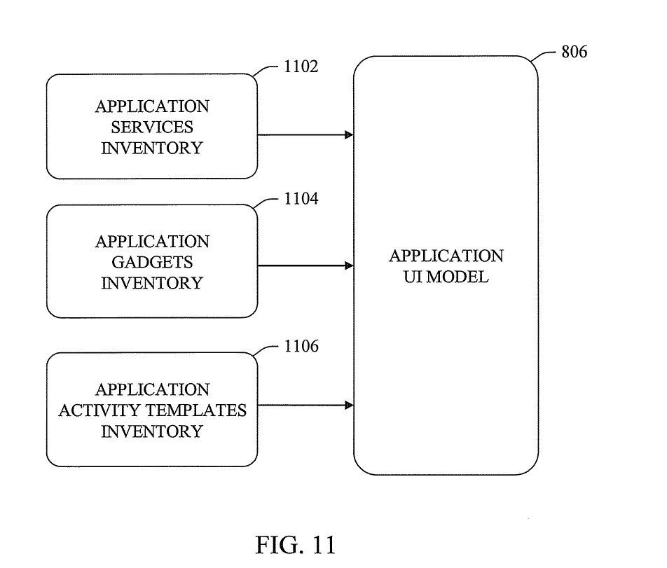

FIG. 11 illustrates that the application UI model 806 can be composed of metadata that describes the application services 1102, application gadgets 1104, and application activity templates 1106. In accordance with one aspect, with respect to the application services inventory 1102, the application program interface (API) of each method is enumerated. For methods that can be called directly and have parameters, information that describes the parameters of the method can be included within the application UI model 806. The parameter information can also include how to get the value for the parameter if it is being called directly (e.g., prompt user with a textbox, use specified default value, etc.). For methods that are not always available to be called, information about the enabling conditions, and actions needed to achieve the conditions can also be included.

In the applications gadgets inventory 1104, data describing each gadget in the application is specified. This data can include a functional description of the gadget and data describing the composite and component UI for each of the gadgets.

In the activity templates inventory 1106, each activity template (or “experience”) that the application contains can be listed. Like gadgets, this data can include a description of the composite and component UI for the activity.

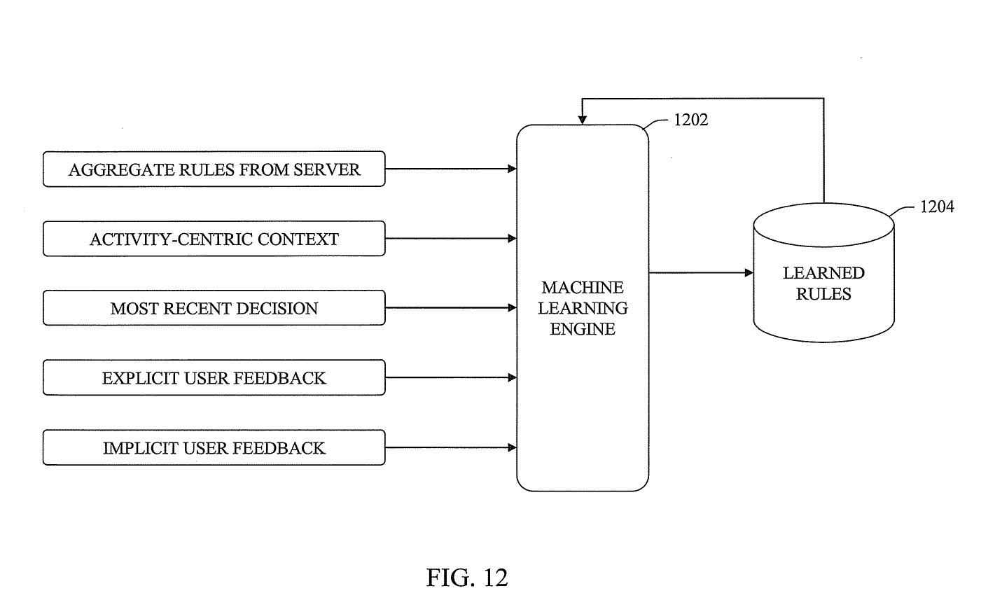

FIG. 12 illustrates an overview of an adaptive UI Machine learning and reasoning (MLR) component 1202 that can be employed to infer on behalf of a user. More particularly, the MLR component 1202 can learn by monitoring the context, the decisions being made, and the user feedback. As illustrated, in one aspect, the MLR component 1202 can take as input the aggregate learned rules (from other users), the context of the most recent decision, the rules involved in the most recent decision and the decision reached, any explicit user feedback, any implicit feedback that can be estimated, and the current set of learned rules. From these inputs, the MLR component 1202 can produce (and/or update) a new set of learned rules 1204.

In addition to establishing the learned rules 1204, the MLR component 1202 can facilitate automating one or more novel features in accordance with the subject innovation. The following description is included to add perspective to the innovation and is not intended to limit the innovation to any particular MLR mechanism. The subject innovation (e.g., in connection to establishing learned rules 1204) can employ various MLR-based schemes for carrying out various aspects thereof. For example, a process for determining implicit feedback can be facilitated via an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic, statistical and/or decision theoretic-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. By defining and applying a kernel function to the input data, the SVM can learn a non-linear hypersurface. Other directed and undirected model classification approaches include, e.g., decision trees, neural networks, fuzzy logic models, naïve Bayes, Bayesian networks and other probabilistic classification models providing different patterns of independence can be employed.

As will be readily appreciated from the subject specification, the innovation can employ classifiers that are explicitly trained (e.g., via a generic training data) as well as implicitly trained (e.g., via observing user behavior, receiving extrinsic information). For example, the parameters on an SVM are estimated via a learning or training phase. Thus, the classifier(s) can be used to automatically learn and perform a number of functions, including but not limited to determining according to a predetermined criteria how/if implicit feedback should be employed in the way of a rule.

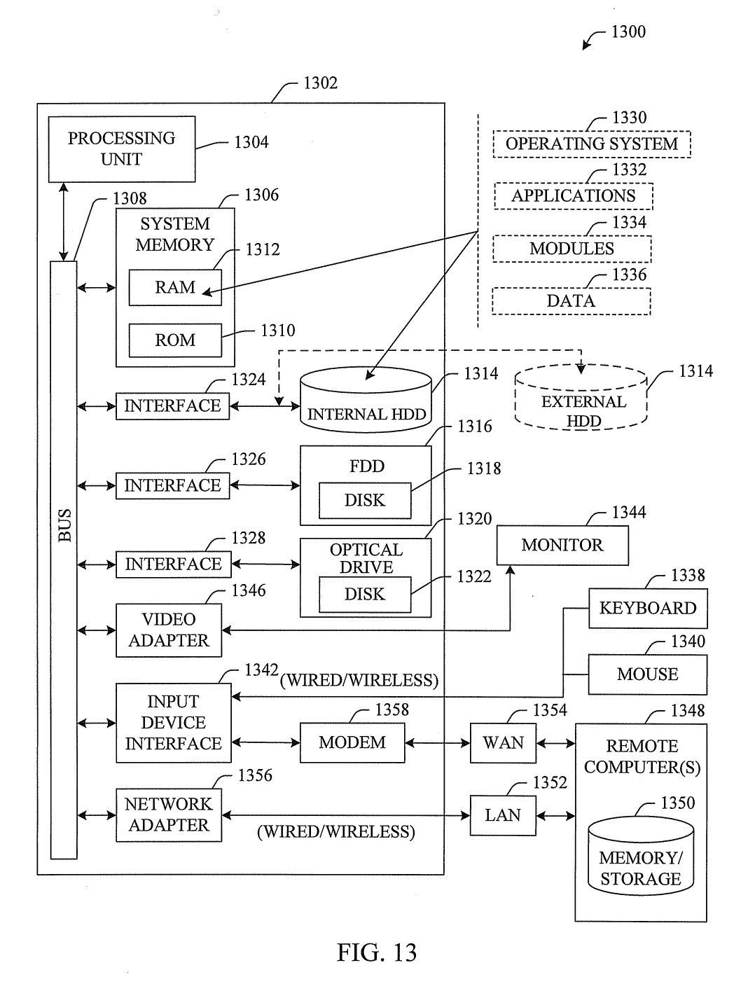

Referring now to FIG. 13, there is illustrated a block diagram of a computer operable to execute the disclosed activity-centric system architecture. In order to provide additional context for various aspects of the subject innovation, FIG. 13 and the following discussion are intended to provide a brief, general description of a suitable computing environment 1300 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 13, the exemplary environment 1300 for implementing various aspects of the innovation includes a computer 1302, the computer 1302 including a processing unit 1304, a system memory 1306 and a system bus 1308. The system bus 1308 couples system components including, but not limited to, the system memory 1306 to the processing unit 1304. The processing unit 1304 can be any of various commercially available processors. Dual microprocessors and other multi-processor architectures may also be employed as the processing unit 1304.

The system bus 1308 can be any of several types of bus structure that may further interconnect to a memory bus (with or without a memory controller), a peripheral bus, and a local bus using any of a variety of commercially available bus architectures. The system memory 1306 includes read-only memory (ROM) 1310 and random access memory (RAM) 1312. A basic input/output system (BIOS) is stored in a non-volatile memory 1310 such as ROM, EPROM, EEPROM, which BIOS contains the basic routines that help to transfer information between elements within the computer 1302, such as during start-up. The RAM 1312 can also include a high-speed RAM such as static RAM for caching data.

The computer 1302 further includes an internal hard disk drive (HDD) 1314 (e.g., EIDE, SATA), which internal hard disk drive 1314 may also be configured for external use in a suitable chassis (not shown), a magnetic floppy disk drive (FDD) 1316, (e.g., to read from or write to a removable diskette 1318) and an optical disk drive 1320, (e.g., reading a CD-ROM disk 1322 or, to read from or write to other high capacity optical media such as the DVD). The hard disk drive 1314, magnetic disk drive 1316 and optical disk drive 1320 can be connected to the system bus 1308 by a hard disk drive interface 1324, a magnetic disk drive interface 1326 and an optical drive interface 1328, respectively. The interface 1324 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1302, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 1312, including an operating system 1330, one or more application programs 1332, other program modules 1334 and program data 1336. All or portions of the operating system, applications, modules, and/or data can also be cached in the RAM 1312. It is appreciated that the innovation can be implemented with various commercially available operating systems or combinations of operating systems.

A user can enter commands and information into the computer 1302 through one or more wired/wireless input devices, e.g., a keyboard 1338 and a pointing device, such as a mouse 1340. Other input devices (not shown) may include a microphone, an IR remote control, a joystick, a game pad, a stylus pen, touch screen, or the like. These and other input devices are often connected to the processing unit 1304 through an input device interface 1342 that is coupled to the system bus 1308, but can be connected by other interfaces, such as a parallel port, an IEEE 1394 serial port, a game port, a USB port, an IR interface, etc.

A monitor 1344 or other type of display device is also connected to the system bus 1308 via an interface, such as a video adapter 1346. In addition to the monitor 1344, a computer typically includes other peripheral output devices (not shown), such as speakers, printers, etc.

The computer 1302 may operate in a networked environment using logical connections via wired and/or wireless communications to one or more remote computers, such as a remote computer(s) 1348. The remote computer(s) 1348 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1350 is illustrated. The logical connections depicted include wired/wireless connectivity to a local area network (LAN) 1352 and/or larger networks, e.g., a wide area network (WAN) 1354. Such LAN and WAN networking environments are commonplace in offices and companies, and facilitate enterprise-wide computer networks, such as intranets, all of which may connect to a global communications network, e.g., the Internet.

When used in a LAN networking environment, the computer 1302 is connected to the local network 1352 through a wired and/or wireless communication network interface or adapter 1356. The adapter 1356 may facilitate wired or wireless communication to the LAN 1352, which may also include a wireless access point disposed thereon for communicating with the wireless adapter 1356.

When used in a WAN networking environment, the computer 1302 can include a modem 1358, or is connected to a communications server on the WAN 1354, or has other means for establishing communications over the WAN 1354, such as by way of the Internet. The modem 1358, which can be internal or external and a wired or wireless device, is connected to the system bus 1308 via the serial port interface 1342. In a networked environment, program modules depicted relative to the computer 1302, or portions thereof, can be stored in the remote memory/storage device 1350. It will be appreciated that the network connections shown are exemplary and other means of establishing a communications link between the computers can be used.

The computer 1302 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11(a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

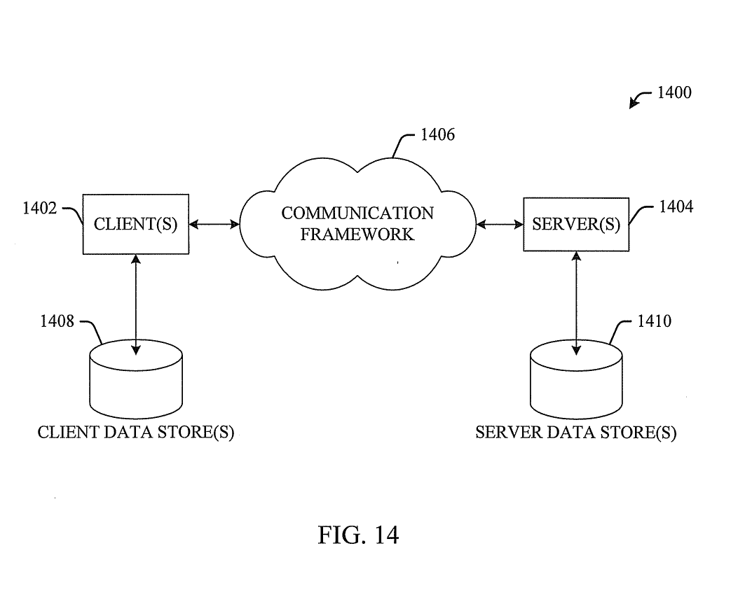

Referring now to FIG. 14, there is illustrated a schematic block diagram of an exemplary computing environment 1400 in accordance with the subject innovation. The system 1400 includes one or more client(s) 1402. The client(s) 1402 can be hardware and/or software (e.g., threads, processes, computing devices). The client(s) 1402 can house cookie(s) and/or associated contextual information by employing the innovation, for example.

The system 1400 also includes one or more server(s) 1404. The server(s) 1404 can also be hardware and/or software (e.g., threads, processes, computing devices). The servers 1404 can house threads to perform transformations by employing the innovation, for example. One possible communication between a client 1402 and a server 1404 can be in the form of a data packet adapted to be transmitted between two or more computer processes. The data packet may include a cookie and/or associated contextual information, for example. The system 1400 includes a communication framework 1406 (e.g., a global communication network such as the Internet) that can be employed to facilitate communications between the client(s) 1402 and the server(s) 1404.

Communications can be facilitated via a wired (including optical fiber) and/or wireless technology. The client(s) 1402 are operatively connected to one or more client data store(s) 1408 that can be employed to store information local to the client(s) 1402 (e.g., cookie(s) and/or associated contextual information). Similarly, the server(s) 1404 are operatively connected to one or more server data store(s) 1410 that can be employed to store information local to the servers 1404.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A system that facilitates adjusting a user interface (UI) in accordance with an activity of a user, comprising:
an activity detection component that identifies the activity based at least in part upon a plurality of actions of the user; and
an adaptive interface component that dynamically determines at least one of an adaptive UI layout, inclusion, and flow based at least in part upon the activity.

2. The system of claim 1, further comprising a component that enables a developer to build a plurality of adaptive UI components based at least in part upon a declarative model that describes capabilities of the adaptive UI, the adaptive interface component employs the declarative model to dynamically determine the UI layout, inclusion or flow with respect to a subset of the plurality of adaptive UI components.

3. The system of claim 1, further comprising a component that enables at least one of a developer and an activity author to build a plurality of adaptive UI experiences using a declarative model that describes a UI experience, the adaptive interface component employs the declarative model to dynamically determine the UI layout, inclusion or flow based at least in part upon an experience.

4. The system of claim 1, the adaptive interface component further comprises an inference engine that dynamically determines at least one of layout, inclusion and flow of the adaptive UI based at least in part upon a declarative UI definition.

5. The system of claim 1, the plurality of actions is based at least in part upon one of a current and a past behavior of the user.

6. The system of claim 1, the adaptive UI component includes a device collaboration component that at least one of predicts and recommends a subset of a plurality of devices for use in accordance with the activity.

7. The system of claim 1, the activity detection component further comprises a context determination component that detects a user context, the activity detection component leverages the user context as part of an inference to render the adaptive UI and recommend a subset of a plurality of devices based in part upon on the user context.

8. The system of claim 1, the activity detection component further comprises a context determination component that detects an environmental context, the activity detection component leverages the environmental context as part of an inference to render the adaptive UI and recommend a subset of a plurality of devices based in part upon on the environmental context.

9. The system of claim 1, the activity detection component further comprises a context determination component that detects a user preference, the activity detection component leverages the user preference as part of an inference to render the adaptive UI and recommend a subset of a plurality of devices based in part upon on the user preference.

10. The system of claim 1, the activity detection component further comprises a context determination component that detects device characteristic, the activity detection component leverages the device characteristic as part of an inference to render the adaptive UI and recommend a subset of a plurality of devices based in part upon on the device characteristic.

11. The system of claim 1, the activity detection component further comprises a context determination component that detects a device capability, the activity detection component leverages the device capability as part of an inference to render the adaptive UI and recommend a subset of a plurality of devices based in part upon on the device capability.

12. The system of claim 1, further compromising a feedback component that collects at least one of implicit and explicit feedback from a plurality of users about rendering of the adaptive UI in order to improve future rendering based upon statistical analysis of feedback for a specific user.

13. The system of claim 12, the feedback component aggregates feedback from the plurality of users and employs at least one of a probabilistic and statistical-based analysis to improve rendering across a broad range of users based upon the aggregated feedback.

14. A method for adapting a UI in accordance with an activity, comprising:
detecting the activity; and
dynamically adapting the UI based upon the activity and context information.

15. The method of claim 14, the act of detecting the activity comprises inferring the activity from a plurality of user actions.

16. The method of claim 14, further comprising gathering a plurality of UI components based at least in part upon a declarative model.

17. The method of claim 15, the act of dynamically adapting the UI includes determining a layout of the plurality of UI components based at least in part upon the activity.

18. The method of claim 15, the act of dynamically adapting the UI includes determining an inclusion of a subset of the plurality of UI components based at least in part upon the activity.

19. The method of claim 15, the act of dynamically adapting the UI comprises determining a flow of the plurality of UI components based at least in part upon the activity.

20. A computer-executable system that generates an adapted UI in accordance with an activity of a user, comprising:
means for detecting activity-centric context data;
means for identifying an activity;
means for identifying an application UI model;
means for establishing an adapted UI model based at least in part upon the activity-centric data, the activity and the application UI model;
means for analyzing a plurality of device profiles; and
means for rendering the adapted UI based at least in part upon the adapted UI model and a subset of the plurality of device profiles.
